(19) United States
(12) Patent Application Publication
(10) Pub. No.: US 2004/0114085 A1
(43) Pub. Date: Jun. 17, 2004

(54) Liquid crystal display device

(75) Inventors: Jyh-Wen Shiu, Hsinchu (TW); Tzu-Yuan Lai, Taichung (TW); Tu-Cheng Chuang, Taiping City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: TOPPOLY OPTOELECTRONICS CORP.,

(21) Appl. No.: 10/319,641

(22) Filed: Dec. 16, 2002

(51) Int. Cl. G02F 1/1339

(52) U.S. Cl. 349/153

(57) ABSTRACT

The invention relates to a liquid crystal display device that includes a pair of glass plates; a connection port located on one side of the glass plates; an adhesive layer adhered the glass plates; a liquid crystal injection port located on the same side of the connection port and formed by the gap of the adhesive layer; and a seal adhesives located outside the liquid crystal injection port to keep the liquid crystal material from leaking after that the liquid crystal material filled with the space between the pair of glass plates. Because the liquid crystal injection port and the connection port are on the same side, operator can coat manually the seal adhesives over the liquid crystal injection port along the edge surfaces of the glass plates to reduce the instability and avoid the seal adhesives polluting the glass plate surfaces during manual coating operation that causes the problems of later module assembly.

### BACKGROUND OF THE INVENTION

1. Field of the Invention

The invention is relates to a liquid crystal display (LCD) device, more particularly to a liquid crystal display (LCD) device with liquid crystal injection port and the connection port located on the same side. During the operation of coating the seal adhesives manually, operator can coat along the edge surfaces of the glass plates. Thus the instability of manual coating is reduced, and it is avoided that spilling the seal adhesives to pollute the glass plates causes the problems of later module assembly process.

2. Description of the Prior Art

As shown in FIG. 1, a liquid crystal display device 1 typically includes a pair of glass plates 10 which are attached to each other with an adhesive layer 12 applied between along the periphery thereof. Moreover, spacer beads (not shown) are applied uniformly between the glass plates 10. The spacer beads and the adhesive layer 12 form a liquid crystal injection space 14 having a thickness(about 1 μm to 5 μm) which corresponds to the total thickness of the spacer beads and the adhesive layer 12. Then, a liquid crystal material is injected into the liquid crystal injection space 14 through the liquid crystal injection port 16 located in the adhesive layer 12. The connection port 18 is located on one side of the glass plates 10, and the liquid crystal injection port 16 used by the immersion method for injecting the liquid crystal material is located on the opposite side of the glass plates 10.

FIG. 2A is a view illustrating an example of such a liquid crystal injection apparatus that is used for injecting a liquid crystal material into a liquid crystal panel. In the following description, the term “liquid crystal panel” refers to a panel whose liquid crystal injection space 14 is not filled with a liquid crystal material, i.e., the panel without a liquid crystal material filling between the glass plates 10 in FIG. 1. A liquid crystal injection apparatus 20 includes a sealed chamber 26 which accommodates both the liquid crystal panel 22 and the liquid crystal material 24, and pressure regulator 28 for regulating the pressure within the sealed chamber 26. The pressure regulator 28 includes two conduits 281 and 282 for communication between the inside and outside of the sealed chamber 26, valves 283 and 284 provided halfway along the conduits 281 and 282, respectively, and a vacuum pump 285 provided at one end of one conduit 281. The liquid crystal panel 22 is supported by a support mechanism (not shown) so as to be movable in the vertical direction. The liquid crystal material 24 is stored in a tray 262 that is provided on the bottom surface of the sealed chamber 26.

The steps of using the liquid crystal injection apparatus to inject a liquid crystal material 24 into a liquid crystal panel 22 are outlined as the following:

(1) First, as shown in FIG. 2A, the liquid crystal panel 22 is located without any contact with the liquid crystal material 24.

(2) The valve 283 is opened while the valve 284 is closed. The vacuum pump 285 is then actuated to evacuate the sealed chamber 26.

(3) Once a predetermined degree of vacuum is achieved, the liquid crystal panel 22 is lowered by the support mechanism (not shown) so that the liquid crystal injection port 16 provided along the lower side of the liquid crystal panel 22 are dipped in the liquid crystal material 24, as shown in FIG. 2B.

(4) Thereafter, the valve 283 is closed while the valve 284 is opened, thus introducing the ambient air into the sealed chamber 26. Then, the ambient pressure is applied onto the surface of the liquid crystal material 24, so that the liquid crystal material 24 is pushed up and filled into the liquid crystal injection space 14, as indicated by an arrow in the figure. Needless to say, the capillary phenomenon also contributes a filling force to the filling process.

After the completion of the injection process, we have to coat the seal adhesives along the glass plates 10 periphery and harden the seal adhesives, currently UV adhesives is used, as shown in FIG. 3A. Then the polarizing sheet is adhered on the surface of the glass plates 10 and the module is assembled.

For conventional usage of the immersion method for injecting liquid crystal, the liquid crystal injection port 16 is located on the opposite side of the connection port 18. There are following drawbacks:

(1) While manually coating the seal adhesives over the liquid crystal injection port 16, it is not easy to control the coating position that causes bad coating as shown in FIG. 3B.

(2) During the process of coating, the seal adhesives is often spilled out to pollute the glass plates 10. We have to use a scraper to scrape away the spilled adhesives over the glass plate 10 surfaces before the polarizing sheet is adhered to the glass plates.

In later module assembly process, the height of the seal adhesives tip must be less than 0.6 mm to meet the requirement of module assembly as shown in FIG. 3C. It is difficult to keep the height within the requirement by manual operation. To meet the assembly specification we often need to do some jobs on scraping and reworking. Thus it may incur the reliability problems and liquid crystal material leakage.

### SUMMARY OF THE INVENTION

In the light of the state of the art described above, it is an object of the present invention to provide a liquid crystal display (LCD) device with liquid crystal injection port and the connection port located on the same side which is immune to the problems of the conventional LCD device described above and which can reduce the instability of manual coating.

It is an another object of this invention to provide a liquid crystal display device with the liquid crystal injection port and the connection port on the same side that the seal adhesives polluting the glass plate surfaces is avoided during manual coating operation. Thus it overcomes curtain obstacles for later module assembly process.

It is a further object of this invention to provide a liquid crystal display device with the liquid crystal injection port and the connection port on the same side, wherein the edge surfaces of the glass plates do not exist seal adhesives tips which cause the problems of module assembly.

In view of the above and other objects which will become apparent as the description proceeds, there is provided according to a general aspect of the present invention a liquid crystal display device which includes a pair of glass plates; a connection port located on the first side of the glass plates; an adhesive layer that is used to adhere the glass plates; a liquid crystal injection port located on the first side of the glass plates and formed by a gap of the adhesive layer; and a seal adhesives located outside the liquid crystal injection port to keep the liquid crystal material from leaking after that the liquid crystal material filled up the space between the pair of glass plates.

Base on the idea described above, wherein the liquid crystal material is injected by the immersion method.

Base on the aforementioned idea, wherein the seal adhesives is coated along the inner edge surfaces of said pair of glass plates.

Base on the idea described above, wherein the seal adhesives does not stick out over the surfaces of said pair of glass plates.

Base on the aforementioned idea, wherein the space thickness between the pair of glass plates is about 1 μm to 5 μm.

Base on the idea described above, wherein the seal adhesives is coated manually.

Base on the aforementioned idea, the liquid crystal display device further comprises a polarizing sheet adhered to the surface of the glass plates.

Base on the idea described above, wherein the seal adhesives is the UV adhesives.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a view of the conventional structure that the liquid crystal injection port and the connection port are located on the opposite sides;

FIGS. 2A˜2B illustrate the structure views of the liquid crystal injection apparatus which injects the liquid crystal material into the glass plates;

FIGS. 3A˜3C illustrate the coating views of the conventional liquid crystal display device;

FIG. 4 illustrates a structure view of the present invention that the liquid crystal injection port and the connection port are located on the same side; and

FIGS. 5A˜5C illustrate the coating views according to the present invention.

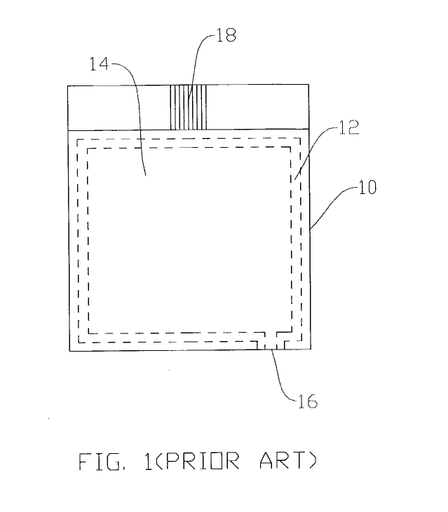

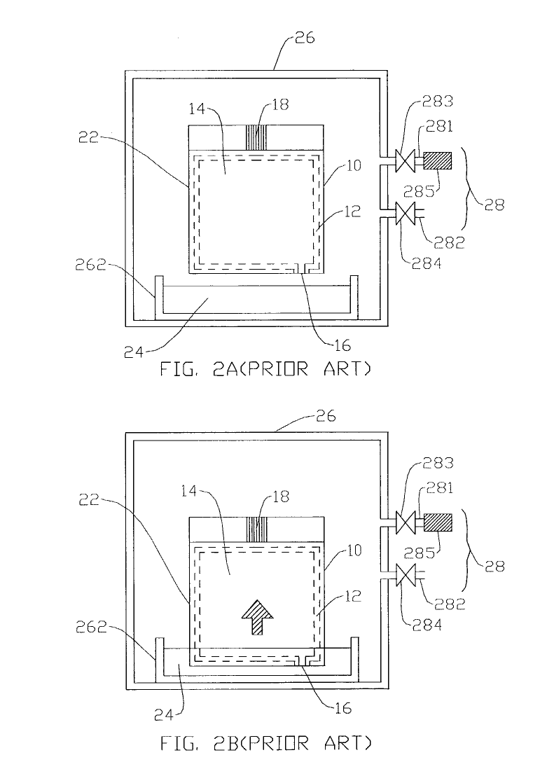

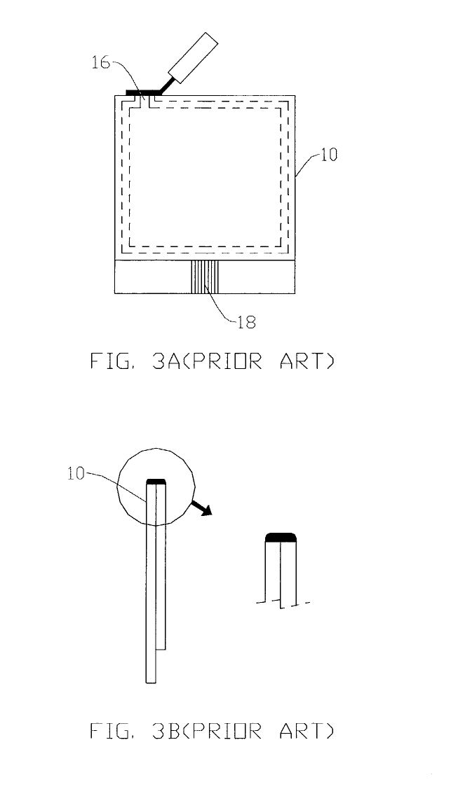

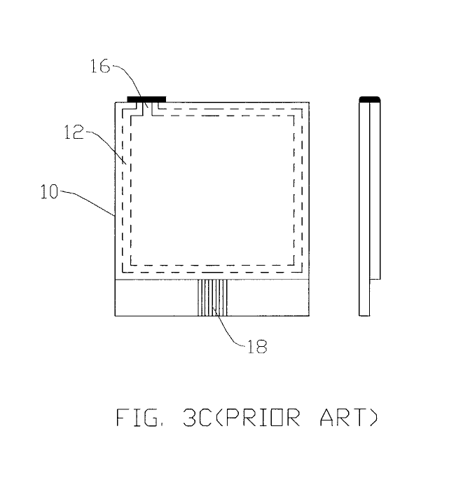

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

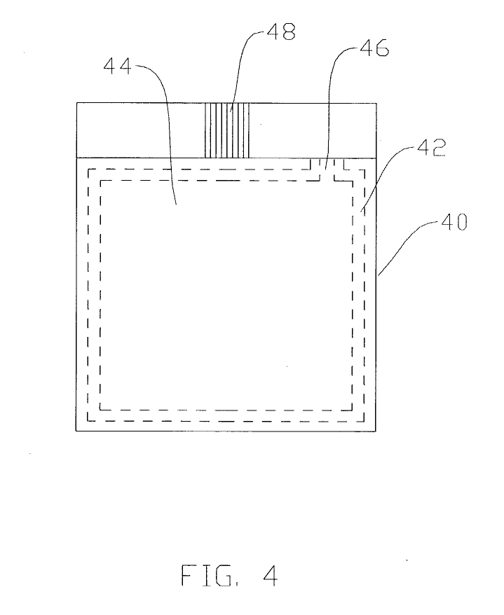

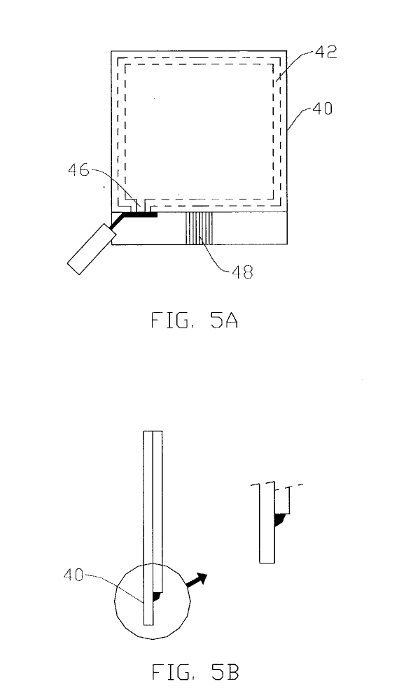

Next, please refer to FIG. 4, which is the view of the presented invention. The liquid crystal display device 4 comprises a pair of glass plates 40, which are attached to each other with an adhesive layer 42 applied between along the periphery thereof. Moreover, spacer beads (not shown) are applied uniformly between the glass plates 40. The spacer beads and the adhesive layer 42 form a liquid crystal injection space 44 having a thickness(about 1 μm to 5 μm) which corresponds to the total thickness of the spacer beads and the adhesive layer 42. Then, a liquid crystal material is injected into the liquid crystal injection space 44 through the liquid crystal injection port 46 located in the adhesive layer 42. What makes this different from the conventional process is that the liquid crystal injection port 46 is located at the same side as the connection port 48.

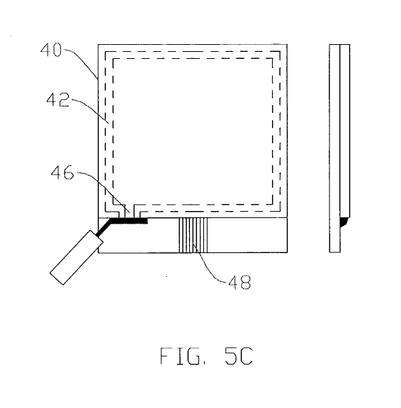

Because the present invention uses the same liquid crystal injection apparatus and technique as the conventional method and they are not the points of the invention, We will not repeat the liquid crystal material injection process again. After the completion of liquid crystal material injection, the next step is to coat the seal adhesives along the glass plates 10 periphery and to harden the seal adhesives, as shown in FIG. 5A. Then the polarizing sheet is adhered on the surface of the glass plates 40 and the module is assembled. The advantages of the present invention are followed:

(1) The stability of manually coating the seal adhesives is improved. In the new adhesive layer 42 coating method the liquid crystal injection port 46 is moved to the same side with the connection port 48. Thus we can coat manually along the edge surfaces of the glass plate 40 to reduce the instability, as shown in FIG. 5B.

(2) During the process of coating, the new adhesive layer 42 coating method avoids the seal adhesives polluting the glass plate 40 surfaces. Thus it can eliminate curtain obstacles for later processing.

(3) In later module assembly process, no seal adhesives tip over the glass plates 40 surface is higher than 0.6 mm height to benefit the module assembly operation as shown in FIG. 5C.

Although the specific embodiment has been illustrated and described, it will be obvious to those skilled in the art that various modifications may be made without departing from what is intended to be limited solely by the appended claims.

What is claimed is:

1. A liquid crystal display device, comprising:
a pair of glass plates;
a connection port located on a first side of said glass plates;
an adhesive layer that is used to adhere said glass plates;
a liquid crystal injection port located on said first side of said glass plates and formed by a gap of said adhesive layer; and
a seal adhesives located outside said liquid crystal injection port to keep the liquid crystal material from leaking after that the liquid crystal material filled up the space between said pair of glass plates.

2. The liquid crystal display device according to claim 1, wherein the liquid crystal material is injected by the immersion method.

3. The liquid crystal display device according to claim 1, wherein said seal adhesives is coated along the inner edge surfaces of said pair of glass plates.

4. The liquid crystal display device according to claim 1, wherein said seal adhesives does not stick out over the surfaces of said pair of glass plates.

5. The liquid crystal display device according to claim 1, wherein the space thickness between said pair of glass plates is about 1 μm to 5 μm.

6. The liquid crystal display device according to claim 1, wherein said seal adhesives is coated manually.

7. The liquid crystal display device according to claim 1 further comprising a polarizing sheet adhered to the surface of said glass plates.

8. The liquid crystal display device according to claim 1, wherein said seal adhesives is the UV adhesives.
